(19) United States
(12) Patent Application Publication
(10) Pub. No.: US 2012/0038842 A1
(43) Pub. Date: Feb. 16, 2012

(54) Phase Modulation Devices for Optical Applications

(75) Inventors: Timothy David Wilkinson, Cambridge (GB); Harry James Coles, Ely (GB); Stephen Matthew Morris, Cambridge (GB); Jing Chen, Cambridge (GB)

(73) Assignee: CAMBRIDGE ENTERPRISE LIMITED, CAMBRIDGE (GB)

(21) Appl. No.: 13/263,953

(22) PCT Filed: Apr. 14, 2010
(86) PCT No.: PCT/GB2010/000753

§ 371 Date: Oct. 11, 2011

(30) Foreign Application Priority Data
Apr. 14, 2009 (GB) 0906377.7

(51) Int. Cl. G02F 1/133

(52) U.S. Cl. 349/33

(57) ABSTRACT

An optical phase modulation device having a layer of flexoelectro-optic effect liquid crystal material and electrode for applying an electric field to the layer of liquid crystal material. In this way, the optic axis of the liquid crystal layer can be deflected. This provides a phase shift to light transiting the liquid crystal layer. The substrate of the device is based on a liquid crystal over silicon (LCOS) microdisplay. The device is capable of providing multilevel phase shifts, e.g. for holographic displays.

### BACKGROUND TO THE INVENTION

1. Field of the Invention

The present invention relates to phase modulation devices for optical applications. Of particular, but not exclusive, interest are phase modulation devices for use in holographic projectors, optical correlators or in adaptive optics applications.

2. Related Art

U.S. Pat. No. 5,182,665 and U.S. Pat. No. 5,552,916 disclose a device for selectively modulating incident unpolarised light passing through a layer of ferroelectric liquid crystal material. The ferroelectric liquid crystal layer has an optic axis that can be sent in a first orientation or a second orientation, dependent on the electric field applied to the ferroelectric liquid crystal layer.

WO 2005/072396 and WO 2007/127758 disclose the use of a spatial light modulator, incorporating a ferroelectric single crystal layer, with a phase mask for use in holographic data storage. The ferroelectric single crystal layer can be located on a CMOS backplane, in a liquid crystal on silicon (LCOS) architecture.

### SUMMARY OF THE INVENTION

The present inventors have realised that a disadvantage of known phase modulation devices using ferroelectric liquid crystal layers is that, although the response times of such devices can be fast (of the order of 1-10 kHz), in practice these devices are limited to binary phase modulation since only two stable states are available through surface stabilization.

To the knowledge of the inventors, there is at present no suitable device for achieving multi-level phase modulation with fast response times. The present invention has been devised in order to address this problem.

Accordingly, in a general aspect, the present invention utilizes a flexoelectro-optic effect liquid crystal material in order to control the phase of light transiting the liquid crystal.

In a first preferred aspect, the present invention provides an optical phase modulation device having a layer of flexoelectro-optic effect liquid crystal material and means for applying an electric field to the layer of liquid crystal material so as to deflect the optic axis of the liquid crystal layer, thereby providing a phase shift to light transiting the liquid crystal layer.

In a second preferred aspect, the present invention provides a method for the phase modulation of light transiting a layer of liquid crystal material, the liquid crystal material being a flexoelectro-optic effect liquid crystal material, the method including applying an electric field to the layer of liquid crystal material so as to deflect the optic axis of the liquid crystal layer, thereby providing a phase shift to the light transiting the liquid crystal layer.

In a third preferred aspect, the present invention provides a holographic display apparatus (e.g. a holographic display projector) including a device according to the first aspect.

In a fourth preferred aspect, the present invention provides a method of displaying holographic images including carrying out a method according to the second aspect.

In a fifth preferred aspect, the present invention provides an optical correlation apparatus including a device according to the first aspect.

In a sixth preferred aspect, the present invention provides a method of correlating a first image with a second image (or filter), including carrying out a method according to the second aspect.

In a seventh preferred aspect, the present invention provides an optical apparatus (e.g. an imaging apparatus for research and/or medical diagnosis) including a device according to the first aspect.

In an eighth preferred aspect, the present invention provides an imaging method (e.g. for research and/or medical diagnosis) including carrying out a method according to the second aspect.

In a ninth preferred aspect, the present invention provides a optical communications apparatus including a device according to the first aspect.

In a tenth preferred aspect, the present invention provides an optical communications method including carrying out a method according to the second aspect.

In any of the seventh to tenth aspects, distortions in wavefronts in an incoming signal may be at least partially compensated for by spatially modulating the phase of the incoming signal. In this way, the present invention may have applications in the field of adaptive optics.

Further preferred and/or optional features of the present invention will now be set out. These are applicable singly or in any combination with any aspect of the invention, unless the context demands otherwise.

Preferably, the phase shift is variable substantially continuously with the electric field applied to the liquid crystal layer. Thus, in practice, for each increment of the strength of the electric field applied to the liquid crystal, within operation limits of the device, there is typically a corresponding change in the phase shift applied to the light. In a practical device, there may be available at least 5 phase shift levels (corresponding to suitable electric field input signals), but preferably significantly more phase shift levels are available, e.g. at least 10, at least 20, at least 30, at least 40 or at least 50 phase shift levels.

Preferably, the phase shift is variable substantially linearly with the electric field applied to the liquid crystal layer. Typically, the phase shift provided to the light varies with the amount of deflection of the optic axis, up to a practical limit. The practical limit typically will be determined by the maximum electric field that can be applied to the liquid crystal, or to the behaviour of the liquid crystal above a threshold electric field.

Preferably, the response time (typically defined as the 10%-90% response time) is 1 ms or less. More preferably, the response time is 500 μs or less, e.g. about 100 μs or faster.

Preferably, the liquid crystal material is a chiral nematic liquid crystal material. Typically, the liquid crystal material has a helical structure.

WO 2006/003441 contains a detailed discussion of flexoelectro-optic liquid crystal materials. The content of WO 2006/003441 is hereby incorporated by reference in its entirety, in particular in respect of its disclosure of suitable properties of and suitable materials for the flexoelectro-optic liquid crystal. However, the devices of WO 2006/003441 are intended to be used to control the polarization state of transmitted light, in order to provide intensity modulation to a communications signal propagating parallel to the helical axis of the flexoelectro-optic liquid crystal.

Preferably, in the flexoelectro-optic liquid crystal used in the present invention, the helical axis is substantially perpendicular to the direction of the applied electric field. In this way, the application of an electric field allows flexo-electric deformation to occur stably.

The helical pitch of the flexoelectro-optic liquid crystal may be shorter than the wavelength of the incident light. The helical pitch of the flexoelectro-optic liquid crystal may be substantially shorter than the wavelength of the incident light. In this way, rotational dispersion effects may be reduced. Furthermore, the use of a short pitch can reduce the response time of the device.

In the device, the layer of liquid crystal has a thickness direction corresponding to its smallest dimension. Typically, the helical axis is substantially perpendicular to the thickness direction. Thus, the helical axis may be parallel to a substrate (described below). In this way, the orientation and geometry of the liquid crystal material may be that of a uniform lying helix (ULH) geometry. However, it is also possible for the helical axis to be non-parallel to the substrate. For example, the helical axis my be perpendicular or substantially perpendicular to the substrate. Such an arrangement is typically referred to as a standing helix arrangement.

Typically, the layer of liquid crystal is held between a substrate and a cover. The cover is typically substantially transparent to the incident light. The means for applying an electric field typically includes an electrode formed at the substrate. More preferably, the means for applying an electric field includes an array of electrodes formed at the substrate. Each may be selectively addressable. Each may correspond to discrete pixels or sub-pixels of the device. Thus, each pixel or sub-pixel may be selectively operable to provide a phase shift to light transiting the liquid crystal layer at the pixel or sub-pixel.

The means for applying an electric field may include an electrode (preferably substantially transparent, e.g. indium tin oxide (ITO) or the like) formed at the cover. This electrode may be a common electrode.

Preferably, the device includes an array of a large number of pixels or sub-pixels. In a one-dimensional array, there may be at least 100 (more preferably at least 1000) pixels or sub-pixels. In a two-dimensional array, there may be at least 100×100 (more preferably at least 100×1000 or 1000×1000) pixels or sub-pixels, or more.

The device may be operable in transmission mode. In this case, the substrate is preferably substantially transparent to the incident light. However, it is preferred that the device operates in reflection mode. The incident light may reflect from the substrate. Preferably, the incident light reflects from a surface of at least one of the electrodes formed on the substrate. An advantage of operating in reflection mode is that the device may be configured to apply a suitable phase shift to the incident light based on a two-way transit through the liquid crystal layer, i.e. from the cover to the substrate and from the substrate to the cover and out of the device.

The device may include a quarter wave plate in the light path. In this way, the phase shift applied to the light may be increased. When operating in reflection mode, the incorporation of a quarter wave plate may therefore double the response of the device. Preferably, the substrate includes at least a layer of semiconductor material, such as silicon. Most preferably, the substrate is based on a LCOS architecture substrate. This is advantageous, since the substrate may be manufactured using known semiconductor manufacturing techniques, and thus electrodes and other electrical circuitry components may be formed on and in the substrate. Such components can be formed spatially exceptionally precisely and at small dimensions.

The thickness of the liquid crystal layer may be 20 μm or less. More preferably, the thickness of the liquid crystal layer may be 10 μm or less. For example, a thickness of about 5 μm is considered suitable.

Many liquid crystal devices include at least one polarizing layer. Such devices typically operate to modulate the intensity of light transiting the device. For example, liquid crystal displays typically operate by rotating the polarization direction of light through a layer of liquid crystal held between crossed polarizing layers. Preferably, in the aspects of the present invention, the light entering and/or exiting the device does not pass through a polarizing layer. In particular, the present invention preferably does not utilize cross polarizing layers. This is because the present invention aims to utilize phase modulation of the light, and the presence of polarizing layers tends to reduce the overall intensity (and thus efficiency) of the device.

### BRIEF DESCRIPTION OF THE DRAWINGS

Preferred embodiments of the present invention will now be set out, with reference to the accompanying drawings, briefly described below:

FIG. 1 shows a schematic of an LCOS embodiment of the invention, viewed from the top and side.

FIG. 2 shows the experimental setup to measure the phase shift and response times of an LCOS embodiment of the invention.

FIGS. 3 and 4 show optical micrographs depicting the ULH alignment of the chiral nematic liquid crystal in an LCOS embodiment of the invention.

FIGS. 5A and 5B show the flexoelectro-optic response of the LCOS device in terms of intensity modulation. FIG. 5A shows the tilt angle and FIG. 5B shows the response time of a chiral nematic liquid crystal mixture for both a glass cell and a LCOS device.

FIGS. 6a, 6b and 6c show phase modulation of a nematic LCOS device. FIG. 6a shows images of the far-field interference for different applied voltages. FIG. 6b shows plots of the phase shift as a function of voltage. The red line represents the Sigmoidal fit of plot.

FIG. 6c shows the response times of the phase shift as a function of electric field for different frequencies.

FIGS. 7a, 7b and 7c show phase modulation of a flexoelectro-optic LCOS device. FIG. 7a shows images of the far-field interference for different applied voltages. FIG. 7b shows a plot of the phase-shift as a function of voltage. The red line represents a linear fit to the plot. FIG. 7c shows the response times of the phase shift for different frequencies.

### DETAILED DESCRIPTION OF THE PREFERRED EMBODIMENTS, FURTHER OPTIONAL FEATURES OF THE INVENTION

Traditional liquid crystal on silicon (LCOS) devices are known. For example, Reference 1 discloses such as the advanced grating chip, which can deliver multi-level phase modulation based on planar aligned nematic liquid crystals (LCs) but, due to cell geometry and visco-elastic properties, are only capable of achieving frame rates of around 100 Hz. Ferroelectric LCOS devices, on the other hand, can deliver frame rates in excess of 10 kHz, but are limited to binary phase modulation due to the two stable states that are available through surface stabilization. Consequently, an electro-optic effect that offers both analogue phase modulations with frame rates in excess of 1 kHz is central to advancements in holographic projection and adaptive optics [References 2-4].

It is known that the flexoelectro-optic effect in chiral nematic LCs, when in the uniform lying helix (ULH) geometry, is a fast switching, in-plane deflection of the optic axis that is linear with an externally applied electric field [References 5, 6]. The flexoelectro-optic effect is characterized by the tilt angle, φ, of the optic axis and the response time, τ. To a first approximation these can be expressed in terms of the macroscopic physical properties as

$$\begin{matrix}tan φ = \frac{eEp}{K 2 π} & ( 1 ) \\ τ = \frac{γ}{K} \frac{{p}^{2}}{4 {π}^{2}} & ( 2 )\end{matrix}$$

where p is the pitch of helix, γ is the relative effective viscosity for the distortion of the helix, e is the average flexoelectric coefficient (e=½(eₛ+e_{b})) and K is the average of the splay and bend elastic constants for the material defined as K=½(K₁₁+K₃₃) where eₛ and e_{b} are the flexoelectric coefficients and K₁₁ and K₃₃, are the elastic constants for splay and bend deformation of the material, respectively.

These expressions show that the tilt angle of the optic axis is linear in the applied electric field and its magnitude is governed by the so-called flexoelastic ratio. The response times, however, can be minimized by selecting a short-pitch chiral nematic liquid crystal. In this work, we have demonstrated flexoelectro-optic switching on a silicon device and verify that a uniform lying helix texture can be obtained using a similar approach to that adopted for conventional glass cell structures. The switching characteristics are found to agree with the results obtained for a control glass cell and that, by recording the phase change from interference fringes in the far-field, fast, multi-level phase modulation is achieved. Such a device is of significance for the development of next-generation holographic applications, for example.

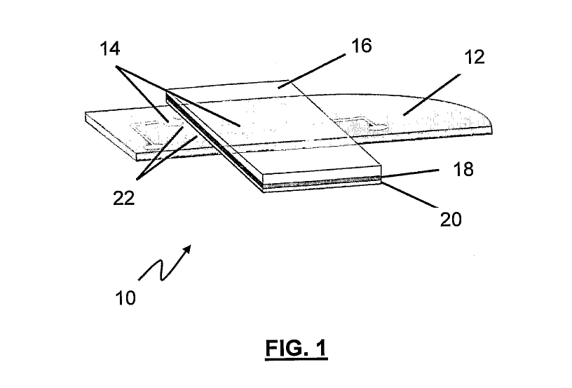

FIG. 1 shows a schematic illustration of an embodiment of the present invention. An LCOS device 10 was formed using a standard silicon very large scale integration (VLSI) process to create a silicon backplane 12 (also including an alignment layer) which contained two parallel aluminum pixels 14 and an addressing circuitry for the bottom substrate. This allowed the device to be used in reflection mode whereby the aluminum pixels on the silicon addressing circuit acted as both an electrode, with which to apply the electric field across the liquid crystal layer, and a ‘mirror’ that enabled the interaction optically with the LC material. On the top of the LCOS device was a glass substrate 16 which was coated with a patterned electrode layer of indium tin oxide (ITO) 18 on the inner side of the glass. A low pre-tilt polyimide alignment layer (AM4276) 20 was rubbed along the long edge of the aluminum pixels on both substrates. The cell gap of the empty cell was created by using 5 μm spacer balls 22 doped in the ultraviolet cured glue seal. The cell gap was then measured using a Fabry-Perot interference technique. The size of the aluminum pixels were 2 mm×6 mm.

The nematic LC mixture used in this study is BL048 (Merck). The chiral nematic LC mixture used in this study consisted of the commercially available nematic LC mixture BL006 (Merck KGaA) and a low concentration (1 wt %) of the high twisting power chiral dopant BDH1305 (Merck KGaA). The pitch of this sample was greater than 600 nm. The resultant mixture was then filled into an empty LCOS device by vacuum-assisted capillary action. After filling the mixture into the LCOS device, a Grandjean texture was obtained at room temperature in the absence of an applied electric field. A surprisingly good ULH texture was obtained in the LCOS device by cooling the mixture from the isotropic phase to room temperature (at 27° C.) under the influence of a bipolar square wave (2.5 V/μm) at a frequency of 100 Hz. Mechanical shearing across the device was used to improve the alignment.

The experimental apparatus used to prepare the ULH texture in the LCOS device, and on which the measurements of the flexoelectro-optic response were carried out, included an Olympus BH-2 reflection polarizing microscope and a Linkam hot-stage, which allowed the temperature to be controlled to within an accuracy of 0.1° C. The flexoelectro-optic response of the LCOS device was measured using a photodiode mounted in the phototube of the microscope, a digitizing oscilloscope (HP54501A, Hewlett-Packard), and an amplified output from a waveform generator (TGA1230, Thurlby-Thandar) in combination with a high voltage amplifier built in-house.

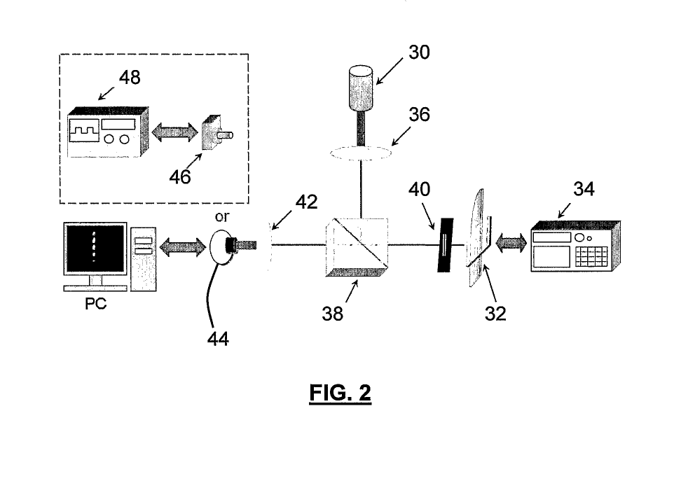

The experiment carried out for phase measurements was similar to Young's double slits experiment but differed in that it used light reflected from the LCOS device (see FIG. 2). The light source 30 was a polarized laser source mounted on a rotator, and the input laser polarization was aligned with the optic axis of the ULH texture in the chiral nematic liquid crystal sample in the LCOS device 32. The laser light was collimated by collimation lens 36 and subsequently met non-polarizing beam splitter 38. Part of the split beam then reached the double slits mask 40, and subsequently the LCOS device 32. The LCOS device 32 was controlled by a signal generator 34. A microscope objective 42 (×5) with a numerical aperture of 0.12 was used to gather the reflected light through the double silts which covered the aluminum pixels of the LCOS device. The double silts for the NLC sample were positioned with a 0.5 mm gap between them and each slit was about 0.4 mm×0.5 mm. The double silts for the chiral nematic liquid crystal sample were also separated by a 0.5 mm gap and had the same area. The aluminum pixels were covered with a ‘double slit’ mask to maximize the phase difference between the two pixels, in such an approach, only one of the pixels was driven by an applied electric field and the other pixel acted as a reference (i.e. no field applied). A charge-coupled device (CCD) camera 44 (Logitech, QVGA) was used to examine the far-field interference pattern of the test device. The fringes were then recorded in the far-field whereby a separation between two maxima was 27l π in phase. For the response time measurements, the CCD camera was replaced with a photodetector 46 (Thorlabs' DET210) with an active area of 0.8 mm² and the microscope objective was changed to a ×40 microscope objective with a numerical aperture of 0.65. The photo-detector was connected to a digitizing oscilloscope 48 (Agilent 54624A) which displayed both the output waveform and measured response time of the phase modulation simultaneously.

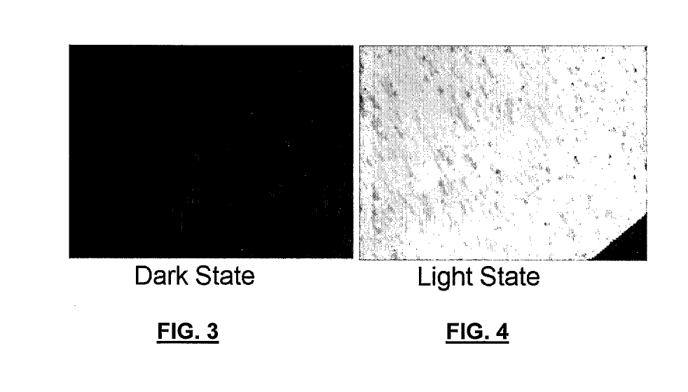

To verify flexoelectro-optic switching in the LCOS test device, the tilt angle and response time were determined from an intensity-based modulation with an electric field at a frequency of 100 Hz. Optical micrographs of the ULH texture on the aluminum pixels taken between crossed polarizers at an applied field of 2V/μm are shown in FIGS. 3 and 4 indicating a relatively good alignment of the optic axis in the plane of the device. This is an encouraging result as it demonstrates that a lying helix can be obtained on silicon substrates. The dark (FIG. 3) and light (FIG. 4) states were obtained by rotating the device between crossed polarizers to align the optic axis at 45° to the transmission axes of the polarizers (light state) and then to align the optic axis with the transmission axis of one of the polarizers (dark state).

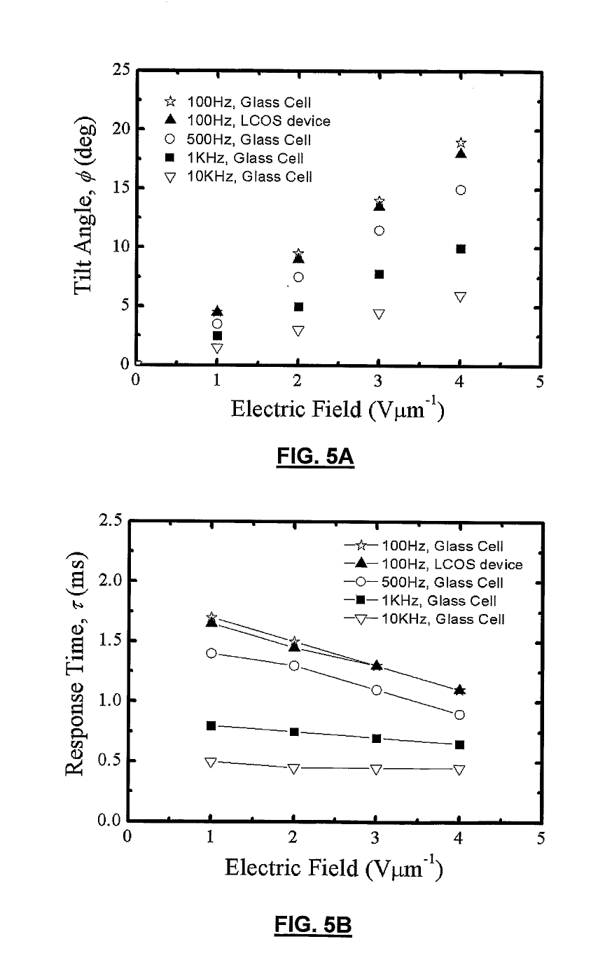

FIG. 5 demonstrates the optical response of the chiral nematic LC in the ULH texture on the LCOS device. The tilt angle and the response time as a function of the applied electric field are plotted separately in FIGS. 5A and 5B, respectively. Measurements were taken for comparison of the same chiral nematic LC mixture but in a conventional 5 μm glass cell at room temperature (T=30° C.) at several different frequencies. It is shown that there is a trade-off between tilt angle and response time in that higher frequencies result in incomplete switching of the optic axis before the polarity of the field is reversed hence smaller tilt angles are observed. These combined results confirm that the electro-optic response in the LCOS device was the same as that observed for the conventional glass cell.

For the LCOS test device, the tilt angle is found to be linearly proportional to the applied electric field, which in accordance with equation (1), verifies flexoelectro-optic switching. When the applied electric field (100 Hz) was increased to 4 μm, the mixture exhibited a tilt angle of 17°, and for phase measurements would give the maximum interferometric contrast between the two switched states. The response times were also measured at the same temperature for different frequencies. These response times correspond to the average of the T₁₀₋₉₀ necessary to achieve 10%-90% of the total value of transmitted light intensity. As the applied electric field was increased, we saw a slight decrease in the response times of the material in a glass cell which is typically observed for flexoelectro-optic switching at large tilt angles [References 8, 9].

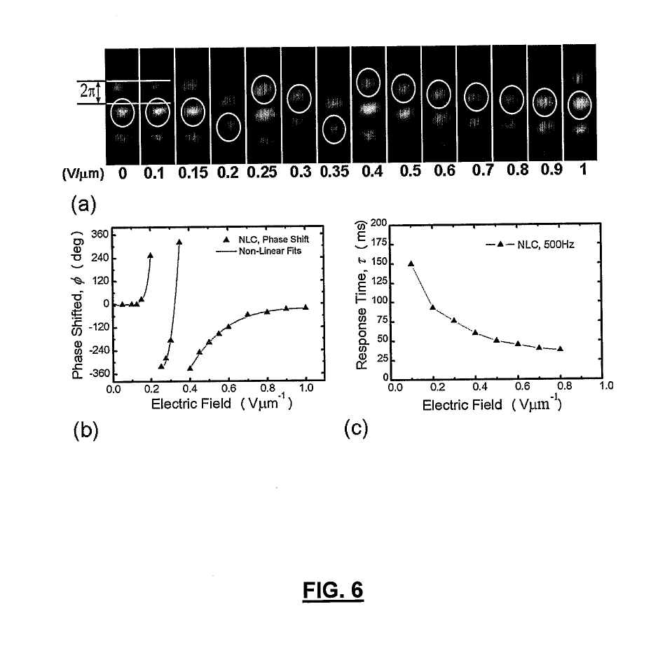

For the purposes of comparison, phase measurements were first carried out using a nematic LC based LCOS device. FIG. 6a shows the CCD camera images of the far-field interference pattern from the LCOS device at different electric field strengths. A straight line is drawn on the image as a reference. As the electric field strength increased, the phase difference between the two pixels changed due to the dielectrically driven reorientation of the LC molecules. Consequently, this reorientation then causes the fringes seen in FIG. 6a to shift accordingly. The phase shifted angle as a function of the applied field is plotted in FIG. 6b where it can be seen that the phase shift was several orders of π, but the responses were not linear in the applied field as expected from nematic-based LCOS devices. Furthermore, the time required for the LC to respond at 500 Hz was 40 ms, see FIG. 6c.

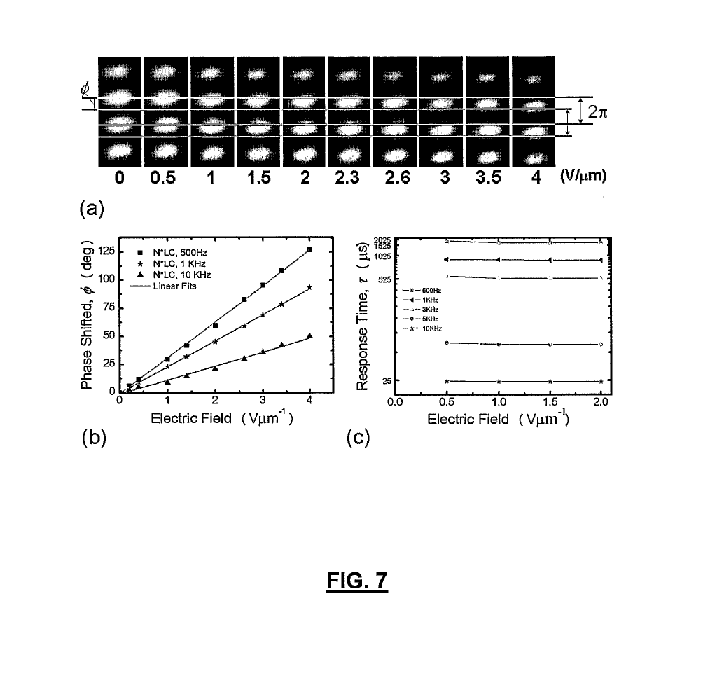

The performance of the chiral nematic LCOS device, on the other hand, is very different, FIG. 7. This figure includes the far-field interference pattern, the electric field dependence of the phase shift, and the response time. These results demonstrate the multi-level phase modulation capability of the device. Unlike the nematic-LCOS device, the phase shift was linear in the applied electric field as expected from the flexoelectric response. At an electric field strength of 4 V m⁻¹, a phase shift of 127° (˜2π/3) was observed. Since a tilt angle of 15° C. leads to a 2π/3 phase shift it is straightforward to realize that for 2π phase shift tilt angles of 45° are required; this is readily achievable using bimesogenic mixtures. The response time of the phase modulation as a function of the applied electric field is plotted in FIG. 7c. The speed of phase modulation in the LCOS device is also frequency dependent in accordance with the reduction of the tilt angle at higher frequencies. With an applied square wave of 1.8 V/μm and frequency of 5 kHz applied to the LCOS device, the response time of the phase modulation was measured at 30 μs. This fast response shows the capability of linear multi-level phase modulation in a LCOS device operating at kHz frame rates.

Multi-level phase modulation may be achieved using bimesogenic mixtures that have been developed in recent years. Good uniform alignment may be achieved using these compounds. The bimesogenic mixtures enable improved response due to the combination of a low dielectric anisotropy and a large flexoelastic ratio which ensures strong flexoelectric coupling of the LC to the applied field whilst at the same time minimizing dielectric coupling. In addition, the present invention may employ newer liquid crystal materials, such as blue phases [Reference 10], chiral doped systems [Reference 11] and multi-color switching materials [Reference 12] to further improve speeds, phase modulation and other optical effects that will lead to even faster frame rates.

One of the key technologies to evolve in the displays market in recent years is liquid crystal over silicon (LCOS) microdisplays. Traditional LCOS devices and applications such as rear projection televisions, have been based on intensity modulation electro-optical effects, however, recent developments have shown that multi-level phase modulation from these devices is extremely sought after for applications such as holographic projectors, optical correlators and adaptive optics. Here, we propose alternative device geometry based on the flexoelectric-optic effect in a chiral nematic liquid crystal. This device is capable of delivering a multi-level phase shift at speeds in excess of 100 μsec which has been verified by phase shift interferometry using an LCOS test device. The flexoelectric on silicon device, due to its remarkable characteristics, enables the next generation of holographic devices to be realized.

Thus, we have demonstrated for the first time an electric field-induced multi-level phase modulation using the flexoelectro-optic effect in LCOS device which is capable of frame rates in excess of several kHz. Such an electro-optical effect is a revolution in the implementation of LCOS devices, allowing for the first time, new applications such as holographic projection and adaptive optics to exploit this frame rate. The limited frame rate of existing phase modulating electro-optical effects has been a major restriction in the use of LCOS phase modulators. By employing flexoelectro-optic based LCOS devices one can now modulate the phase of light at frame rates well in excess of the response time of the eye, allowing the improvement of image quality in holographic projectors as well as the implementation of real-time adaptive optic ophthalmic imaging for the high resolution diagnosis of retinal disease.

### REFERENCES AND LINKS

1. M. L. Jepsen, “A technology rollercoaster Liquid crystal on silicon,” Nature Photon. 1, 276-277 (2007).
2. T. D. Wilkinson, D. C. O'Brien, R. J. Mears, “Dynamic asymmetric binary holograms using ferroelectric liquid crystals spatial light modulator,” Opt. Commun. 109, 222-226 (1994).
3. S. Mias, L. G. Manolis, N. Collings, T. D. Wilkinson, and W. A. Crossland, “Phase-modulating bistable optically addressed spatial light modulators using wide switching-angle ferroelectric liquid crystal layer,” Opt. Eng. 44(1), 014003 (2005).
4. C. J. Henderson, D. G. Leyva, and T. D. Wilkinson, “Free Space Adaptive Optical Interconnect at 1.25 Gb/s, With Beam Steering Using a Ferroelectric Liquid-Crystal SLM,” J. J. Lightw. Technol. 24, 1989-1997 (2006).
5. R. B. Meyer, “Piezoelectric Effects in Liquid Crystals,” Phys. Rev. Lett. 22, 918 (1969).
6. J. S Patel & R. B. Meyer, “Flexoelectric electro-optics of a cholesteric liquid crystal,” Phys. Rev. Lett. 58, 1538 (1987).
7. T. D. Wilkinson, C. J. Henderson, D. G. Leyva, and W. A. Crossland, “Phase modulation with the next generation of liquid crystal over silicon technology,” J. Mater. Chem., 16, 3359-3365 (2006).
8. H. J. Coles, M. J. Clarke, S. M. Morris, B. J. Broughton, and A. E. Blatch, “Strong flexoelectric behavior in bimesogenic liquid crystals,” J. Appl. Phys. 99, 034104 (2006).
9. B. J. Broughton, M. J. Clarke, A. E. Blatch, and H. J. Coles, “Optimized flexoelectric response in a chiral liquid-crystal phase device,” J. Appl. Phys. 98, 034109 (2005).
10. H. J. Coles and M. N. Pivnenko, “Liquid crystal ‘blue phase’ with a wide temperature range,” Nature, 436, 997-1000 (2005).
11. J. Thisayukta, H. Niwano, H Takezoe and J. Watanabe, “Effect of chiral dopant on a helical 5 ml phase of banana-shaped N-n-O-PIMB molecules,” J. Mater. Chem., 11, 2717-2721 (2001).
12. J. Chen, S. M. Morris, T. D. Wilkinson, and H. J. Coles, “Reversible color switching from blue to red in a polymer stabilized chrial nematic liquid crystals,” Appl. Phys. Lett. 91, 121118 (2007).

1. An optical phase modulation device having a layer of flexoelectro-optic effect liquid crystal material and means for applying an electric field to the layer of liquid crystal material so as to deflect the optic axis of the liquid crystal layer, thereby providing a phase shift to light transiting the liquid crystal layer.

2. An optical phase modulation device according to claim 1 wherein the phase shift is variable substantially continuously with the electric field applied to the liquid crystal layer.

3. An optical phase modulation device according to claim 1 wherein the device provides at least 5 different phase shift levels based on the electric field strength applied to the liquid crystal.

4. An optical phase modulation device according to claim 3 wherein the phase shift is variable substantially linearly with the electric field applied to the liquid crystal layer.

5. An optical phase modulation device according to claim 1 wherein the response time of the device, defined as the 10%-90% response time, is 1 ms or less.

6. An optical phase modulation device according to claim 1 wherein the liquid crystal material is a chiral nematic liquid crystal material having a helical structure.

7. An optical phase modulation device according to claim 6 wherein the principal axes of the chiral nematic liquid crystal helical structures are aligned substantially perpendicular to the direction in which the electric field is applicable.

8. An optical phase modulation device according to claim 6 wherein a helical pitch of the helical structures is shorter than the wavelength of the light transiting the liquid crystal layer.

9. An optical phase modulation device according to claim 6 wherein the layer of liquid crystal has a thickness direction corresponding to its smallest dimension and the principal axes of the chiral nematic liquid crystal helical structures are substantially perpendicular to the thickness direction.

10. An optical phase modulation device according to claim 6 wherein the orientation and geometry of the liquid crystal material is a uniform lying helix geometry.

11. An optical phase modulation device according claim 1 wherein the layer of liquid crystal is held between a substrate and a cover, the cover being substantially transparent to the incident light.

12. An optical phase modulation device according to claim 11 wherein the substrate includes at least a layer of semiconductor material.

13. An optical phase modulation device according to claim 11 wherein the substrate is based on a liquid crystal over silicon (LCOS) architecture substrate.

14. An optical phase modulation device according to claim 11 wherein the means for applying an electric field includes an array of electrodes formed at the substrate, corresponding to discrete pixels or sub-pixels of the device, each pixel or sub-pixel being selectively operable to provide a phase shift to light transiting the liquid crystal layer at the pixel or sub-pixel.

15. An optical phase modulation device according to claim 1 wherein the device does not include a polarizing layer.

16. A holographic display apparatus including an optical phase modulation device having a layer of flexoelectro-optic effect liquid crystal material and means for applying an electric field to the layer of liquid crystal material so as to deflect the optic axis of the liquid crystal layer, thereby providing a phase shift to light transiting the liquid crystal layer.

17. An optical correlation apparatus including an optical phase modulation device having a layer of flexoelectro-optic effect liquid crystal material and means for applying an electric field to the layer of liquid crystal material so as to deflect the optic axis of the liquid crystal layer, thereby providing a phase shift to light transiting the liquid crystal layer.

18. A method for the phase modulation of light transiting a layer of liquid crystal material, the liquid crystal material being a flexoelectro-optic effect liquid crystal material, the method including applying an electric field to the layer of liquid crystal material so as to deflect the optic axis of the liquid crystal layer, thereby providing a phase shift to the light transiting the liquid crystal layer.

19. A method according to claim 18 wherein the phase shift is varied substantially continuously with the electric field applied to the liquid crystal layer.

20. A method according to claim 18 wherein the phase shift is variable substantially linearly with the electric field applied to the liquid crystal layer.

21. A method according to claim 18 wherein light entering and/or exiting the device does not pass through a polarizing layer.
